(19) United States
(12) Patent Application Publication
(10) Pub. No.: US 2009/0283696 A1
(43) Pub. Date: Nov. 19, 2009

(54) Pre-Cryogenic Electron Microscope Specimen Holder

(75) Inventor: Chih-Yuan Tang, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: E HONG INSTRUMENTS CO., LTD., Taipei City (TW)

(21) Appl. No.: 12/467,550

(22) Filed: May 18, 2009

(30) Foreign Application Priority Data
May 19, 2008 (TW) 97118410

(51) Int. Cl. G21K 5/10

(52) U.S. Cl. 250/442.11

(57) ABSTRACT

A pre-cryogenic electron microscope specimen holder is disclosed. The pre-cryogenic electron microscope specimen holder includes a specimen holding member and a cryogenic energy storing member. The cryogenic energy storing member further includes a liquid gas storing trench formed therein to store the liquid gas. The cryogenic energy storing member is disposed under the specimen holding member to further supply the cryogenic energy to the specimen to extend the observation time for the specimen in an electron microscope.

### RELATED APPLICATIONS

The present application is based on, and claims priority from, Taiwan Application Serial Number 97118410, filed May 19, 2008, which is herein incorporated by reference.

### FIELD OF THE INVENTION

The present invention generally relates to an electron microscope specimen holder. More particularly, this invention relates to a pre-cryogenic electron microscope specimen holder.

### BACKGROUND OF THE INVENTION

For the research purposes, people usually try to observe a specimen of a small organization to see the detailed structure thereof or to know a root cause of a defect. Following improvements in science and technology, the sizes of the specimens are decreasing and the specimens are varied.

A conventional optical microscope is insufficient to observe partial new specimens because the limitation of the amplification factor of the conventional optical microscope is about 1000. Electron microscopes are used to observe smaller specimens. The electron microscope uses an electron beam with a wavelength shorter than the wavelengths of light waves.

A first electron microscope was the transmission electron microscope (TEM) developed in 1931. Meanwhile, because the resolutions of scanning electron microscopes (SEM) are insufficient when observing smaller specimens and the image processing and signal processing technologies are also limited, researchers are no longer interested in using the scanning electron microscope even though the scanning electron microscope was designed in 1935. The scanning electron microscopes are more popular until 1965 due to the technical improvement and therefore the development thereof is expeditious. Nowadays, the performance of the scanning electron microscopes and the accessories thereof are more advanced. Scanning electron microscopes can be used in various scopes such as research in material engineering, mechanical engineering, electrical engineering, electronic engineering, metallurgy, geology, mineral science, medical science, chemical engineering and physical engineering.

Normally, to observe the specimen with the electron microscope, the specimen is placed in a vacuum chamber. The specimen has to be dehydrated through some chemical treatments. These chemical treatments may deform the specimen. Hence, the real structure of a biological specimen is difficult to observe. To overcome this defect, a cryogenic electron microscope was developed. The temperature of the specimen for the cryogenic electron microscope is reduced to lower than the freezing point to keep the water in the specimen while the specimen is placed in the vacuum chamber of the cryogenic electron microscope. Therefore, the real structure of the biological specimen can be observed.

The cryogenic electron microscope normally requires a liquid nitrogen cooling system to keep the temperature of the specimen lower than the freezing point while observing the specimens. Accordingly, the cryogenic electron microscope with the liquid nitrogen cooling system is very expensive and unfavorable for a small laboratory or a school. Therefore, the cryogenic electron microscope is not available to all users. Hence, there is a need to reduce the cost for observing a cryogenic specimen with the electron microscope.

### SUMMARY OF THE INVENTION

One objective of the present invention is to provide a pre-cryogenic electron microscope specimen holder to pre-freeze a specimen outside an electron microscope and keep the specimen temperature lower than the freezing point with the cryogenic energy stored in the specimen holder to observe the specimen in the electron microscope.

Another objective of the present invention is to provide a pre-cryogenic electron microscope specimen holder to prevent atmospheric moisture adhering on a surface of a specimen protected by a vaporized liquid gas stored in the specimen holder so as to prevent the moisture from being frozen on the surface of the specimen.

To achieve these and other advantages and in accordance with the objective of the present invention, as the embodiment broadly describes herein, the present invention provides a pre-cryogenic electron microscope specimen holder including a specimen holding member and a cryogenic energy storing member. The specimen holding member supports a specimen thereon and users can use an electron microscope without a cryogenic vacuum chamber to observe the specimen. The specimen holding member further includes a liquid gas storing trench to store a liquid gas, for example, a liquid nitrogen, therein. When the liquid gas is vaporized, the vaporized liquid gas can effectively form a gaseous protecting layer protecting the specimen to prevent iced globs sticking to the surface of the specimen due to the moisture in the air frozen on the surface of the specimen. Users can clearly observe the specimen without the iced glob influence. The cryogenic energy storing member is preferably disposed under the specimen holding member to continuously supply the cryogenic energy to the specimen to extend the observation time on the specimen in the electron microscope.

The specimen holding member further includes a specimen supporting surface for supporting the specimen. In addition, the specimen holding member further includes an exterior wall encircling the specimen holding member to store the liquid gas. The exterior wall is preferably higher than the specimen supporting surface, and more preferably the exterior wall is higher than the specimen disposed on the specimen supporting surface.

The specimen supporting surface further includes an interior wall encircling the specimen supporting surface and the interior wall is higher than the specimen supporting surface. In addition, the bottoms of the exterior wall and the interior wall are preferably lower than the specimen supporting surface to increase the volume of the liquid gas storing trench.

The cryogenic energy storing member further includes a fixing device formed on a bottom surface of the cryogenic energy storing member to couple to a corresponding fixing device in the electron microscope. The pre-cryogenic electron microscope specimen holder further uses a coupling member to couple to the specimen holding member and the cryogenic energy storing member. The coupling member is preferably an adjusting device to adjust a height of the specimen holding member. In one preferred embodiment, the adjusting device, such as a bolt and a nut, has threads to raise or lower the specimen holding member. The pre-cryogenic electron microscope specimen holder is made of metal, for example, aluminum, copper or stainless steel. Alternatively, the pre-cryogenic electron microscope specimen holder is made of nonmetal material, such as carbon. Furthermore, the pre-cryogenic electron microscope specimen holder further includes a clamping trough formed between the specimen holding member and the cryogenic energy storing member to easily clamp and move the pre-cryogenic electron microscope specimen holder.

Hence, the pre-cryogenic electron microscope specimen holder according to the present invention can utilize the liquid gas, such as the liquid nitrogen, to pre-cooling the specimen, and then the specimen is observed in the electron microscope and the cryogenic energy storing member can continuously maintain the specimen at the desired low temperature. Therefore, the electron microscope can easily observe the biological specimen without an additional cryogenic vacuum chamber. Furthermore, the liquid gas stored in the liquid gas storing trench can effectively form a gaseous protecting layer to prevent the specimen from the surrounding air so as to prevent iced globs forming on the specimen. Therefore, the air protecting layer can effectively protect the specimen from the surrounding air influence. Accordingly, the pre-cryogenic electron microscope specimen holder according to the present invention can reduce the cost of observing the cryogenic specimen and improve the observation quality thereof. Therefore, the cryogenic specimen observation can be more popular to the biological researcher, and the teachers and the students in the school.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1A illustrates a lateral view of a preferred embodiment of a pre-cryogenic electron microscope specimen holder according to the present invention; and

FIG. 1B illustrates a top view of the preferred embodiment of FIG. 1.

### DETAILED DESCRIPTION OF THE PREFERRED EMBODIMENT

The following description is of the best presently contemplated mode of carrying out the present invention. This description is not to be taken in a limiting sense but is made merely for the purpose of describing the general principles of the invention. The scope of the invention should be determined by referencing the appended claims.

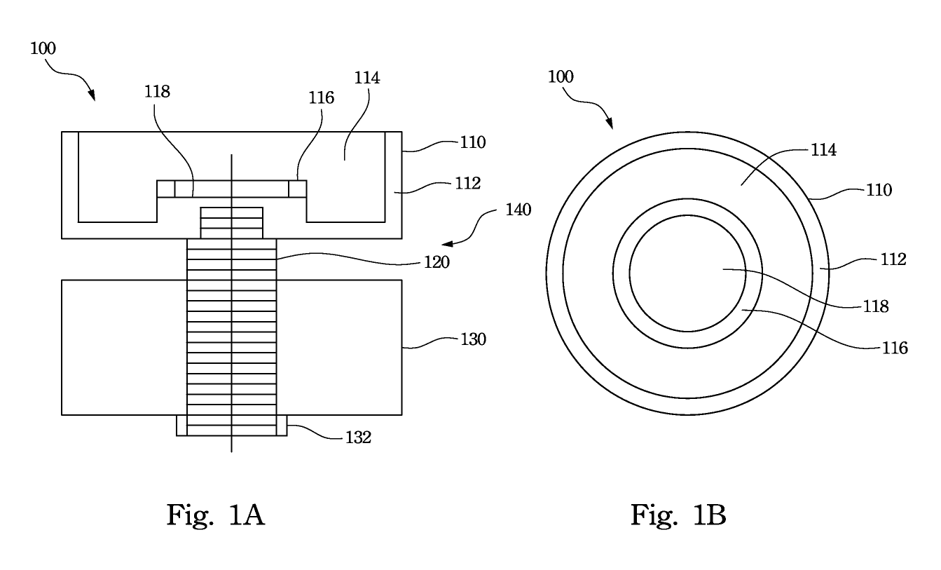

Refer to FIG. 1A and FIG. 1B. FIG. 1A illustrates a lateral view of a preferred embodiment of a pre-cryogenic electron microscope specimen holder according to the present invention and FIG. 1B illustrates a top view thereof. The pre-cryogenic electron microscope specimen holder 100 includes a specimen holding member 110, a cryogenic energy storing member 130 and a coupling member 120 coupling the specimen holding member 110 and the cryogenic energy storing member 130. In one preferred embodiment, the coupling member 120 can adjust the relative height of the specimen holding member 110 on the cryogenic energy storing member 130.

The specimen holding member 110 includes an exterior wall 112 and a liquid gas storing trench 114 formed therein. The specimen holding member 110 further includes a specimen supporting surface 118 near the center of the specimen holding member 110 for placing a specimen to be observed thereon. An interior wall 116 is formed on the peripheral of the specimen supporting surface 118 and the interior wall 116 is preferably higher than the specimen supporting surface 118.

For observing a specimen at a lower temperature, for example, the temperature is lower than the freezing point, the specimen is first placed on the specimen supporting surface 118 of the pre-cryogenic electron microscope specimen holder 100, and the pre-cryogenic electron microscope specimen holder 100 including the specimen is dipped into a liquid gas, for example, liquid nitrogen. The temperatures of the specimen and the pre-cryogenic electron microscope specimen holder 100 are rapidly reduced to freeze the water in the specimen. Subsequently, the specimen and the pre-cryogenic electron microscope specimen holder 100 can be placed into a normal electron microscope to observe the specimen therein.

The specimen is frozen by the liquid gas, for example, the liquid nitrogen or the equivalent thereof. The water inside the specimen is frozen therein. The cryogenic energy storing member 130 disposed under the specimen holding member 110 can provide the cryogenic energy to the specimen within a predetermined period while observing the specimen in the electron microscope. Therefore, the user can easily observe the specimen in a normal electron microscope without a cryogenic vacuum chamber therein.

Furthermore, the exterior wall 112 of the specimen holding member 110 is preferably higher than the specimen supporting surface 118, and more preferably higher than the specimen disposed on the specimen supporting surface 118. When the pre-cryogenic electron microscope specimen holder 100 is taken out from the liquid gas, the liquid gas storing trench 114 can store the liquid gas, such as the liquid nitrogen. Before the specimen and the pre-cryogenic electron microscope specimen holder 100 are placed into the electron microscope, the vaporized liquid gas can form a gaseous protecting layer for isolating the specimen from the air. Therefore, the vaporized liquid gas can prevent the specimen from iced globs due to frozen moisture of the air. The specimen can therefore be clearly observed without the iced globs thereon. The bottoms of the exterior wall 112 and the interior wall 116 are preferably lower than the specimen supporting surface 116 to increase the volume of the liquid gas storing trench 114.

The coupling member 120 and the cryogenic energy storing member 130 preferably include threads, for example, the threads of a bolt and a nut, to adjust the height of specimen supporting surface 118, that is, the height of the specimen holding member 110. A fixing device 132 is preferably fixed under the cryogenic energy storing member 130 to couple with a corresponding fixing device in the electron microscope to conveniently position the pre-cryogenic electron microscope specimen holder 100 in the electron microscope. A clamping trough 140 is preferably formed between the specimen holding member 110 and the cryogenic energy storing member 130 so that the pre-cryogenic electron microscope specimen holder 100 can be easily clamped and moved.

The specimen holding member of the pre-cryogenic electron microscope specimen holder according to the present invention includes the liquid gas storing trench to store the liquid gas therein. In addition, after the specimen is frozen by the liquid gas, the cryogenic energy storing member can continuously maintain the specimen at the desired low temperature. Furthermore, the liquid gas stored in the liquid gas storing trench can form a gaseous protecting layer to prevent the specimen from the surrounding air so as to avoid forming iced globs on the specimen. The exterior wall is preferably higher than the specimen supporting surface, and more preferably the exterior wall is higher than the specimen disposed on the specimen supporting surface. Therefore, the air protecting layer can effectively protect the specimen from the surrounding air influence. The periphery of the specimen supporting surface preferably includes an interior wall to secure the specimen on the specimen supporting surface.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

What is claimed is:

1. A pre-cryogenic electron microscope specimen holder, comprising:
a specimen holding member for disposing a specimen thereon, wherein the specimen holding member further includes a liquid gas storing trench to store a liquid gas therein and the liquid gas is vaporized to form a gaseous protecting layer around the specimen; and
a cryogenic energy storing member disposed under the specimen holding member to provide cryogenic energy to the specimen to extend an observation time for the specimen being observed in an electron microscope.

2. The pre-cryogenic electron microscope specimen holder of claim 1, wherein the specimen holding member comprises:
a specimen supporting surface for supporting the specimen.

3. The pre-cryogenic electron microscope specimen holder of claim 2, wherein the specimen holding member further comprises:
an exterior wall encircling the specimen holding member to store the liquid gas.

4. The pre-cryogenic electron microscope specimen holder of claim 3, wherein the exterior wall is higher than the specimen supporting surface.

5. The pre-cryogenic electron microscope specimen holder of claim 4, wherein the exterior wall is higher than the specimen disposed on the specimen supporting surface.

6. The pre-cryogenic electron microscope specimen holder of claim 3, wherein the specimen supporting surface further comprises an interior wall encircling the specimen supporting surface and the interior wall is higher than the specimen supporting surface.

7. The pre-cryogenic electron microscope specimen holder of claim 6, wherein bottoms of the exterior wall and the interior wall are lower than the specimen supporting surface to increase a volume of the liquid gas storing trench.

8. The pre-cryogenic electron microscope specimen holder of claim 6, wherein the cryogenic energy storing member further comprises a fixing device formed on a bottom surface of the cryogenic energy storing member to couple to a corresponding fixing device in the electron microscope.

9. The pre-cryogenic electron microscope specimen holder of claim 1, further comprising a coupling member coupled between the specimen holding member and the cryogenic energy storing member.

10. The pre-cryogenic electron microscope specimen holder of claim 9, wherein the coupling member is an adjusting device to adjust a height of the specimen holding member.

11. The pre-cryogenic electron microscope specimen holder of claim 10, wherein the adjusting device comprises a thread to rise or lower the specimen holding member.

12. The pre-cryogenic electron microscope specimen holder of claim 1, wherein the pre-cryogenic electron microscope specimen holder is made of metal.

13. The pre-cryogenic electron microscope specimen holder of claim 1, wherein the pre-cryogenic electron microscope specimen holder is made of aluminum, copper or stainless steel.

14. The pre-cryogenic electron microscope specimen holder of claim 1, wherein the pre-cryogenic electron microscope specimen holder is made of nonmetal material.

15. The pre-cryogenic electron microscope specimen holder of claim 1, wherein the pre-cryogenic electron microscope specimen holder is made of carbon.

16. The pre-cryogenic electron microscope specimen holder of claim 1, further comprising a clamping trough formed between the specimen holding member and the cryogenic energy storing member to easily move the pre-cryogenic electron microscope specimen holder.

17. The pre-cryogenic electron microscope specimen holder of claim 1, wherein the liquid gas comprises liquid nitrogen.
